(19) United States
(12) Patent Application Publication
(10) Pub. No.: US 2009/0109427 A1
(43) Pub. Date: Apr. 30, 2009

(54) Conversion Of Properties Of Light To Frequency Counting

(76) Inventors: Ng Mei Yee, Perak (MY); Chew Gim Eng, Penang (MY)

Correspondence Address: Kathy Manke;Avago Technologies Limited, 4380 Ziegler Road, Fort Collins, CO, 80525, US

(21) Appl. No.: 11/932,501

(22) Filed: Oct. 31, 2007

(51) Int. Cl. G01J 1/46

(52) U.S. Cl. 356/218

(57) ABSTRACT

In an embodiment, the invention provides a method for measuring properties of light of a photoelectric device. A capacitor is charged through a switch until a first voltage is obtained. After the capacitor is charged to the first voltage, the switch is opened from the capacitor and the capacitor is discharged through a photoelectric device, which conducts current when acted upon by a property of light, until a second voltage is obtained. The capacitor is charged and discharged in the manner previously described until the frequency of the voltage on the capacitor is determined. When the frequency of the voltage on the capacitor is determined, an electrical signal is generated that is proportional to the frequency of the voltage on the capacitor.

### BACKGROUND

Various devices require the conversion of properties of light into electrical signals. These devices are often used in applications such as ambient light measurement, light absorption/reflection in products, photographic equipment, colorimetry, chemical analyzers and display contrast controls or any system requiring a wide dynamic range and/or high resolution digital measurement of light intensity. Other applications include notebook computers, tablet computers, flat-panel televisions, cell phones, digital cameras, street light control, security lighting, sunlight harvesting, machine vision, and automotive instrumentation clusters.

A device requiring the conversion of properties of light into electrical properties may perform the functions of light sensing, signal conditioning, and A/D (analog to digital) conversion on a single monolithic IC (integrated circuit). A device may convert light intensity into a digital format for use with a microcontroller. A color sensor may be used to detect a particular frequency of light. A color sensor with a digital output often makes use of pipelined A/D conversion. These devices often require a large amount of area on an IC or on a printed circuit board. In addition to the large amount of area required, these devices often use a large amount of power.

Analog signal conditioning is often required between a sensor, a photodiode for example, and an A/D converter. A result of having analog signal conditioning between a sensor and an A/D converter is that the speed at which sensing occurs is reduced.

### BRIEF DESCRIPTION OF THE DRAWINGS

FIG. 1 is a schematic diagram of an embodiment of a device for converting properties of light into electrical signals.

FIG. 2 is a timing diagram of an embodiment of a device for converting properties of light into electrical signals.

FIG. 3 is a frequency plot of a simulation of an embodiment of a device for converting properties of light into electrical signals where the current through a photodiode is 10 nA.

FIG. 4 is a frequency plot of a simulation of an embodiment of a device for converting properties of light into electrical signals where the current through a photodiode is 20 nA.

FIG. 5 is a frequency plot of a simulation of an embodiment of a device for converting properties of light into electrical signals where the current through a photodiode is 50 nA.

FIG. 6 is a flow chart illustrating an embodiment of a method for converting properties of light into electrical signals.

### DETAILED DESCRIPTION

An embodiment of the invention converts light intensity into a variable frequency “sawtooth” voltage waveform. In this embodiment, photocurrent from a photodiode is converted to a “sawtooth” voltage waveform by a capacitor and a comparator. In this embodiment, the “sawtooth” voltage waveform frequency varies in proportion to the light intensity. In this embodiment, a frequency converter converts the “sawtooth” voltage waveform frequency into an electrical signal indicating the intensity of light. The electrical signal in this example may be an analog electrical signal or a digital electrical signal.

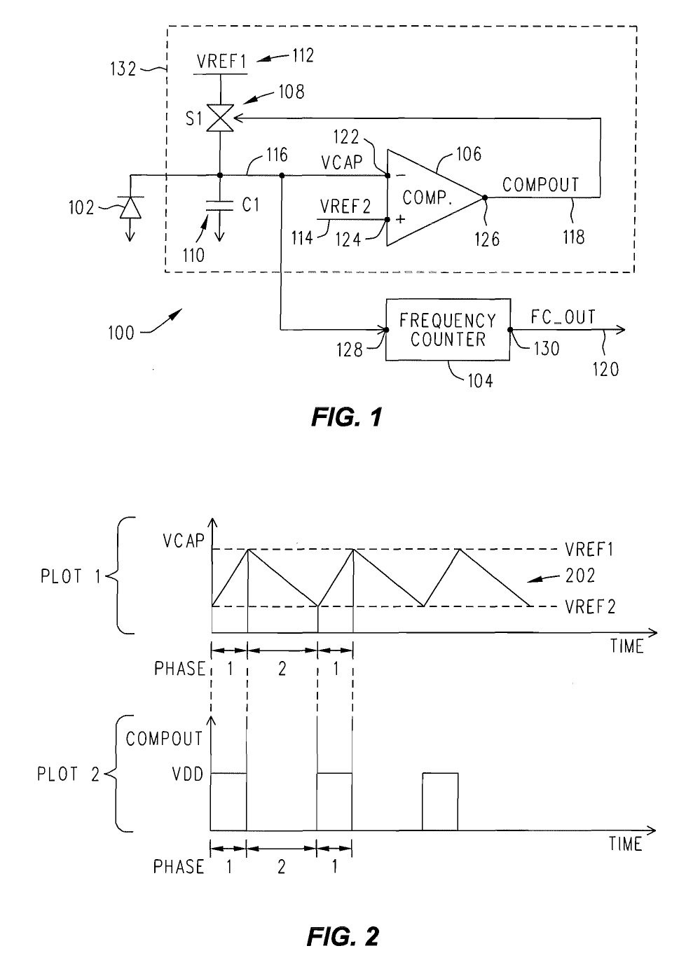

FIG. 1 is a schematic diagram of an embodiment of a device, 100, for converting properties of light into electrical signals. Properties of light include, but are not limited to, the intensity of light and the frequency of light. In this embodiment, a capacitor C1, 110, is electrically connected to GND and node VCAP, 116. Electrical switch S1, 108, is electrically connected to voltage reference VREF1, 112, COMPOUT, 118, and VCAP, 116. A photoelectric device, 102, is electrically connected to GND and VCAP, 116. A comparator, 106, has a first electrical input, 122, connected to VCAP, 116, a second electrical input, 124, connected to voltage reference, VREF2, 114, and an electrical output, 126, connected to node COMPOUT, 118. Node VCAP, 116, is connected to an electrical input, 128, of the frequency counter, 104, and an output, 130, of the frequency counter, 104, is connected to node FC_OUT, 120. In FIG. 1, a charging/discharging device is represented by the box 132.

Referring to an embodiment of the invention in FIG. 1, when switch S1, 108, is closed, capacitor C1, 110, is charged to voltage reference VREF1, 112. When capacitor C1, 110, is charged to voltage reference VREF1, 112, the voltage on the first input, 122, of comparator 106 is at voltage reference VREF1, 112. The voltage of reference VREF2, 114 is chosen to be lower than the voltage of VREF1, 112. When the first input, 122, of the comparator, 106, is charged to VREF1, 112, the output, 126, of the comparator, 106, drives node COMPOUT, 118, to “off.” Because node COMPOUT, 118, is “off” the switch, S1, 108, is open. When switch S1, 108, opens, node VCAP, 116, is not connected to voltage reference, VREF1, 112.

With switch S1, 108, open and voltage reference VREF1, 112, not connected to node VCAP, 116, capacitor C1, 110, begins to discharge through the photoelectric device, 102. The photoelectric device 102, for example a photodiode, discharges the capacitor C1, 110, because a property of light is causing the photoelectric device 102 to conduct current. The current conducted through the photoelectric device 102 discharges the capacitor C1, 110. The current conducted through the photoelectric device 102 may be caused by the intensity of the light, the frequency of the light, or other properties of light.

When the voltage on node VCAP, 116, is discharged below the voltage of voltage reference, VREF2, 114, the output, 126, of the comparator, 106, is turned “on.” When the node COMPOUT, 118 is turned “on”, switch S1, 108, is closed. With switch S1, 108, closed, node VCAP, 116, is electrically connected to voltage reference VREF1, 112. With VCAP, 116, electrically connected to voltage reference VREF1, 112, capacitor C1, 110, begins to charge. Capacitor C1, 110, will charge until it reaches the voltage of VREF1, 112. When capacitor C1, 110, reaches the voltage of VREF1, 112, the output, 126, will switch “off” causing the switch S1, 108, to open.

The charging of capacitor C1, 110, through switch S1, 108, and the discharging of capacitor C1, 110, through the photoelectric device will cause the voltage on node VCAP, 116, to swing between VREF2, 114, and VREF1, 112. The frequency at which node VCAP, 116, swings between VREF2, 114 and VREF1, 112, is determined by the size of capacitor C1, 110, the voltage difference between VREF1, 112, and VREF2, 114, and the current conducted through the photoelectric device.

FIG. 2 is a timing diagram of an embodiment of a device for converting properties of light into electrical signals. FIG. 2 shows two plots of voltage versus time. In plot 1, the voltage VCAP, 116, is plotted as function of tine while discharging and charging capacitor C1, 110. In plot 2, the voltage on node COMPOUT, 118, is plotted as function of time while discharging and charging capacitor C1, 110.

During phase 1 as shown in FIG. 2, node COMPOUT, 118 is “on.” “On” in this example means that node, COMPOUT, 118, is VDD. VDD may represent a positive value of a power supply used with the comparator 106. When node COMPOUT, 118 is at VDD, switch S1, 108, closes connecting VREF1, 112, to capacitor C1, 110. During phase 1 the voltage on node VCAP, 116, charges from VREF2, 114 to VREF1, 112, as shown in plot 1 of FIG. 2.

During phase 2 as shown in FIG. 2, node COMPOUT, 118 is “off.” “Off” in this example means that the node, COMPOUT, 118, is GND. When node COMPOUT, 118 is at GND, switch S1, 108, opens disconnecting VREF1, 112, from capacitor C1. During phase 2, the voltage VCAP, 116, on capacitor, C1, 110, is discharged through the photoelectric device 102 from voltage VREF1, 112, to voltage VREF2, 114 as shown in plot 1 of FIG. 2. Repeating phases 1 and 2 creates a “sawtooth” voltage waveform, 202, as shown in FIG. 2. The frequency of the “sawtooth” waveform, 202, is determined by the size of capacitor C1, 110, the voltage difference between VREF1, 112, and VREF2, 114, and the current conducted through the photoelectric device, 102.

When the size of capacitor C1, 110, is fixed and the voltage difference between VREF1, 112, and VREF2, 114 is fixed, the frequency of the “sawtooth” waveform, 202, is dependent on the magnitude of the current conducted through the photoelectric device 102. If the current through the photoelectric device 102 is increased the frequency of the “sawtooth” waveform, 202, is increased. If the current through the photoelectric device 102 is decreased the frequency of the “sawtooth” waveform, 202, is decreased.

Switch S1, 108, may be implemented using various types of transistors. These transistors include but are not limited to NFET (N-type Field Effect Transistor) transistors, PFET (P-type Field Effect Transistor) transistors or bipolar transistors. The absolute voltage used to turn “on” these transistors as switches varies with each transistor. For example, a logical zero may be used to turn “on” a PFET transistor and a logical one may be used to turn “on” an NFET transistor.

The photoelectric device 102 shown in FIG. 1 may implemented with various types of photoelectric devices. These include but are not limited to photodiodes and photocells. The output, 130, of the frequency counter 104 may increase in magnitude as the frequency increases or the output, 130, of the frequency counter 104 may decrease in magnitude as frequency increases depending on the requirements of the system using the output 130. The output, 130, may be an analog electrical signal or a digital electrical signal. The output, 130, represents the magnitude of the current generated by a photoelectric device. VREF1, 112, may be a constant voltage reference or a constant current reference.

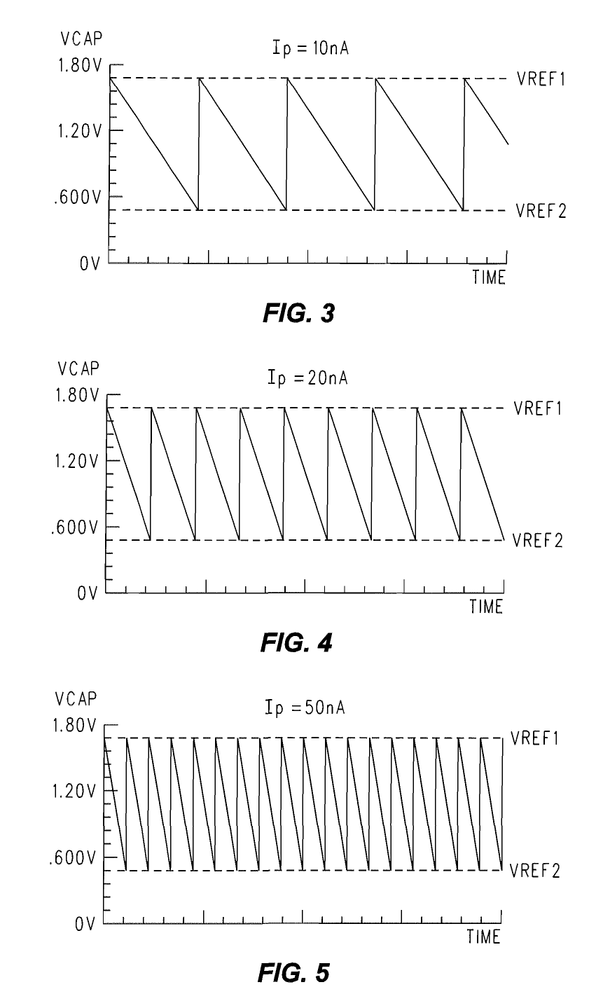

FIG. 3 is a frequency plot of a simulation of an embodiment of a device for converting properties of light into electrical signals where the current through a photodiode is 10 nA. Voltage is represented on the Y-axis of the plot and time is represented on the X-axis of the plot. The voltage, VCAP, 116, on the Y-axis ranges from 0 volts to 1.8 volts in this example. The diode current, Ip, in this example is 10 na. A “sawtooth” voltage, VCAP, 116, waveform is created by charging and discharging capacitor C1, 110, between the voltages of VREF1, 112, and VREF2, 114. The frequency of this voltage, VCAP, 116, waveform is proportional to the magnitude of diode current, Ip.

FIG. 4 is a frequency plot of a simulation of an embodiment of a device for converting properties of light into electrical signals where the current through a photodiode is 20 nA. Voltage is represented on the Y-axis of the plot and time is represented on the X-axis of the plot. The voltage, VCAP, 116, on the Y-axis ranges from 0 volts to 1.8 volts in this example. The diode current, Ip, in this example is 20 na. A “sawtooth” voltage, VCAP, 116, waveform is created by charging and discharging capacitor C1, 110, between the voltages of VREF1, 112, and VREF2, 114. The frequency of this voltage, VCAP, 116, waveform is proportional to the magnitude of diode current, Ip. The frequency of the voltage, VCAP, 116, waveform shown in FIG. 4 is greater than the frequency of the voltage, VCAP, 116, waveform shown in FIG. 3 because the magnitude of the diode current, Ip, in FIG. 4 is greater than the magnitude of the diode current, Ip, in FIG. 3.

FIG. 5 is a frequency plot of a simulation of an embodiment of a device for converting properties of light into electrical signals where the current through a photodiode is 50 nA. Voltage is represented on the Y-axis of the plot and time is represented on the X-axis of the plot. The voltage, VCAP, 116, on the Y-axis ranges from 0 volts to 1.8 volts in this example. The diode current, Ip, in this example is 50 na. A “sawtooth” voltage, VCAP, 116, waveform is created by charging and discharging capacitor C1, 110, between the voltages of VREF1, 112, and VREF2, 114. The frequency of this voltage, VCAP, 116, waveform is proportional to the magnitude of diode current, Ip. The frequency of the voltage, VCAP, 116, waveform shown in FIG. 5 is greater than the frequency of the voltage waveforms shown in FIGS. 3 and 4 because the magnitude of the diode current, Ip, in FIG. 5 is greater than the magnitude of the diode current, Ip, shown in FIGS. 3 and 4.

It can be seen that when comparing the frequency of the voltage waveforms shown in FIGS. 3, 4 and 5 the frequency of the voltage waveforms increases as the diode current, Ip, increases. In these three examples, the value of the capacitor, C1, 110, remains constant. In addition, in these examples the values VREF1, 112, and VREF2 remain constant. It may be appreciated that changing the value of C1, 110, VREF1, 112, or VREF2, 114 will result in a change in the frequency of the voltage waveforms shown in FIGS. 3, 4 and 5.

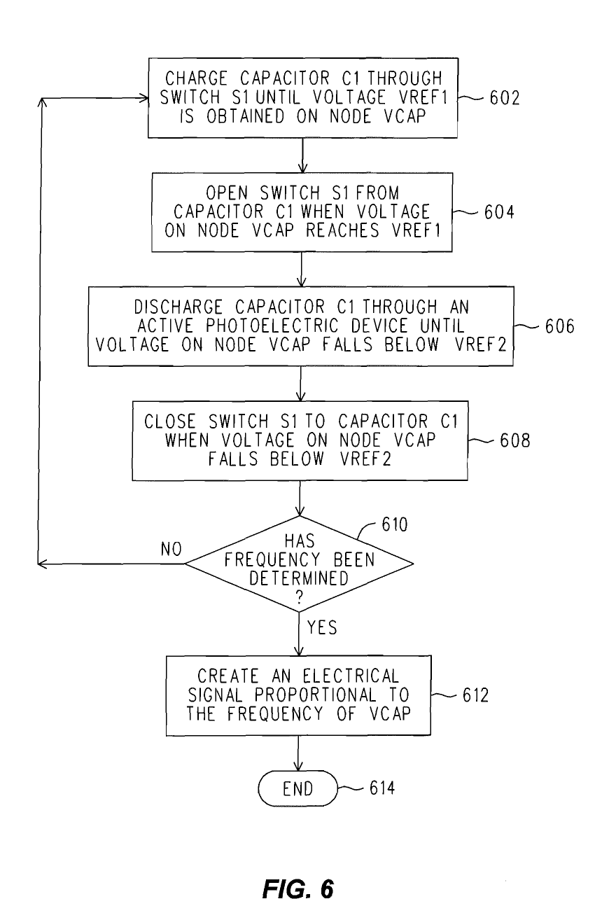

FIG. 6 is a flow chart illustrating an embodiment of a method for converting properties of light into electrical signals. Box 602 describes a capacitor C1, 110, that is charged through switch S1, 108, until the voltage on node VCAP, 116, reaches the voltage of voltage reference, VREF1, 112. Box 604 describes a switch S1, 108, that is opened from the capacitor C1, 110, when the voltage on node VCAP, 116, reaches the voltage of voltage reference VREF1, 112. Box 606 describes a capacitor C1, 110, that begins to discharge through an active photoelectric device 102 after switch S1, 108, is opened from the capacitor, C1, 110, and continues to discharge until the voltage on node VCAP, 116, falls below the reference voltage VREF2, 112. Box 608 describes a condition that when the voltage on node VCAP, 116, falls below the reference voltage VREF2, 112, the switch S1, 108, closes to capacitor C1, 110. The process of charging capacitor, C1, 110 to the voltage of voltage reference VREF1, 112 and discharging capacitor, C1, 110, until the voltage on node VCAP, 116, falls below the reference voltage, VREF2, 112, is repeated until the frequency of the voltage on node VCAP, 116, is determined, 610. When the frequency of the voltage on node VCAP, 116, is determined, 612, the output, 130 of the frequency counter, 104, outputs an electrical signal, FC_OUT, 120, that is proportional to the current conducted through the photoelectric device 102. The electrical signal, FC_OUT, 120, may be an analog electrical signal or a digital electrical signal.

One advantage, among others, of an embodiment of this invention is that it operates nearly independent of process and temperature variation. When VREF1, 112, and VREF2, 114, are derived from the same voltage reference, their variation with process and temperature variation has a minimal effect on its operation because VREF1, 112, and VREF2, 114, nearly track each other resulting in a constant VREF1−VREF2 difference.

Another advantage of an embodiment of this invention is that it operates nearly independent of noise. When VREF1, 112, and VREF2, 114, are derived from the same voltage reference, noise presented on nodes VREF1, 112, and VREF2, 114, is nearly canceled because the noise is presented nearly equally on both VREF1, 112, and VREF2, 114.

Other advantages of this invention include that it requires very little area to implement and that it consumes less power than other similar sensor devices. In addition, an embodiment of this invention converts light intensity into meaningful information faster than other similar sensor devices without reducing accuracy.

The foregoing description has been presented for purposes of illustration and description. It is not intended to be exhaustive or to limit the invention to the precise form disclosed, and other modifications and variations may be possible in light of the above teachings. The exemplary embodiments were chosen and described in order to best explain the applicable principles and their practical application to thereby enable others skilled in the art to best utilize various embodiments and various modifications as are suited to the particular use contemplated. It is intended that the appended claims be construed to include other alternative embodiments except insofar as limited by the prior art.

What is claimed is:

1) A device comprising:
a photoelectric device;
a charging/discharging device; and
a frequency counter;
wherein the photoelectric device is electrically connected to the charging/discharging device;
wherein the charging/discharging device is electrically connected to the frequency counter;
wherein the photoelectric device converts a property of light into electrical current;
such that the electrical current drawn through the photoelectric device discharges the charging/discharging device;
such that a frequency of a charging and discharging of the charging/discharging device is determined by the frequency counter;
such that an output of the frequency counter is proportional to the frequency of the charging and discharging of the charging/discharging device.

2) The device as in claim 1 wherein the charging/discharging device comprises:
a capacitor;
a first reference voltage; and
a second reference voltage;
wherein the capacitor is charged to the voltage of the first reference voltage;
wherein the capacitor is discharged to the voltage of the second reference voltage by the electrical current drawn though the photoelectric device.

3) The device as in claim 2 further comprising:
a switch;
wherein the capacitor is charged to the voltage of the first reference voltage when the switch is closed;
wherein the capacitor is discharged to the voltage of the second reference voltage by the electrical current drawn though the photoelectric device when the switch is open.

4) The device as in claim 3 further comprising:
a comparator;
wherein the capacitor is charged to the voltage of the first reference voltage when the switch is closed, the switch being closed when a first input of the comparator fall below the voltage of the second reference voltage;
such that the output of the comparator electrically closes the switch;
wherein the capacitor is discharged to the voltage of the second reference voltage by the electrical current drawn though the photoelectric device when the switch is open, the switch being open when the first input of the comparator reaches the voltage of the first reference voltage;
such that the output of the comparator electrically opens the switch;
wherein the second reference voltage is electrically connected to a second input of the comparator.

5) The device as in claim 3 wherein the switch is selected from the group consisting of N-FET transistors, P-FET transistors and bipolar transistors.

6) The device as in claim 1 wherein the photoelectric device is selected from the group consisting of photodiodes and photocells.

7) The device as in claim 1 wherein the property of light is intensity.

8) The device as in claim 1 wherein the property of light is frequency.

9) The device as in claim 1 wherein the output of the frequency counter is selected from the group consisting of digital signals and analog signals.

10) A method for measuring properties of light comprising:
a) charging a capacitor through a switch until a first voltage is obtained on the capacitor;
b) opening the switch from the capacitor when the first voltage is obtained;
c) discharging the capacitor through a photoelectric device that conducts current when acted upon by a property of light until a second voltage on the capacitor is obtained;
d) repeating a, b, and c until the frequency of the voltage presented on the capacitor is determined;
e) creating an electrical signal that is proportional to the frequency of the voltage presented on the capacitor.

11) The method of claim 10 wherein the switch is opened by an output of a comparator when a voltage presented on a first input of the comparator is equal to the voltage of a first reference voltage.

12) The method of claim 10 wherein the switch is closed by an output of a comparator when a voltage presented on a first input of the comparator falls below a voltage of a second reference voltage.

13) The method of claim 10 wherein the frequency of the voltage presented on the capacitor is determined by a frequency counter.

14) The method of claim 10 wherein an increase in the frequency of the voltage presented on the capacitor indicates an increase in the electrical current drawn by the photoelectric device.

15) The method of clam 10 wherein a decrease in the frequency of the voltage presented on the capacitor indicates a decrease in the electrical current drawn by the photoelectric device.

16) A system comprising:
a device wherein the device comprises:
a photoelectric device;
a charging/discharging device; and
a frequency counter;
wherein the photoelectric device is electrically connected to the charging/discharging device;
wherein the charging/discharging device is electrically connected to the frequency counter;
wherein the photoelectric device converts a property of light into electrical current;
such that the electrical current drawn through the photoelectric device discharges the charging/discharging device;
such that a frequency of a charging and discharging of the charging/discharging device is determined by the frequency counter; such that an output of the frequency counter is proportional to the frequency of the charging and discharging of the charging/discharging device.

17) The system of claim 16 wherein the charging/discharging device comprises:
a capacitor;
a first reference voltage; and
a second reference voltage;
wherein the capacitor is charged to the voltage of the first reference voltage;
wherein the capacitor is discharged to the voltage of the second reference voltage by the electrical current drawn though the photoelectric device.

18) The system of claim 17 further comprising:
a switch;
wherein the capacitor is charged to the voltage of the first reference voltage when the switch is closed;
wherein the capacitor is discharged to the voltage of the second reference voltage by the electrical current drawn though the photoelectric device when the switch is open.

19) The system of claim 18 further comprising:
a comparator;
wherein the capacitor is charged to the voltage of the first reference voltage when the switch is closed, the switch being closed when a first input of the comparator falls below the voltage of the second reference voltage;
such that the output of the comparator electrically closes the switch;
wherein the capacitor is discharged to the voltage of the second reference voltage by the electrical current drawn though the photoelectric device when the switch is open, the switch being open when the first input of the comparator reaches the voltage of the first reference voltage;
such that the output of the comparator electrically opens the switch;
wherein the second reference voltage is electrically connected to a second input of the comparator.

20) The system as in claim 16 wherein the system is selected from the group consisting of LED displays, computers, flat-panel displays, cell phones and digital cameras.
